(19) United States
(12) Patent Application Publication
(10) Pub. No.: US 2012/0158276 A1
(43) Pub. Date: Jun. 21, 2012

(54) VEHICLE DRIVING INFORMATION PROVISION APPARATUS AND METHOD

(75) Inventors: Hyun-Suk KIM, Daejeon (KR); Hae Sook JEON, Daejeon (KR); Jeong Ah JANG, Daejeon (KR); Jong-Woo CHOI, Daejeon (KR); Dae-Sub YOON, Daejeon (KR); Kyong-Ho KIM, Daejeon (KR)

(73) Assignee: Electronics and Telecommunications Research Institute, Daejeon-city (KR)

(21) Appl. No.: 13/279,908

(22) Filed: Oct. 24, 2011

(30) Foreign Application Priority Data
Dec. 15, 2010 (KR) 10-2010-0128632

(51) Int. Cl. G08G 1/00

(52) U.S. Cl. 701/119; 701/117

(57) ABSTRACT

Disclosed herein is a vehicle driving information provision apparatus installed in a vehicle and configured to include a communication unit, a location information collection unit, a control unit and a warning delivery unit. The communication unit receives vehicle driving information from a server installed on a roadside, the vehicle driving information corresponding to a managing section of the server. The location information collection unit collects vehicle location information, including information about latitude, longitude and direction of the vehicle. If the vehicle driving information corresponds to a traffic situation that has occurred ahead of the vehicle based on the vehicle location information, the control unit determines whether the traffic situation is a dangerous situation using the vehicle driving information. If the control unit determines that the traffic situation is a dangerous situation, the warning delivery unit delivers a warning message corresponding to the vehicle driving information.

### CROSS REFERENCE TO RELATED APPLICATION

This application claims the benefit of Korean Patent Application No. 10-2010-0128632, filed on Dec. 15, 2010, which is hereby incorporated by reference in its entirety into this application.

### BACKGROUND OF THE INVENTION

1. Technical Field

The present invention relates generally to a vehicle driving information provision apparatus and method. More particularly, to an apparatus and method for providing information about the operation of a vehicle using a warning determination algorithm.

2. Description of the Related Art

Conventional vehicle driving information provision apparatuses collect information about the operation of a vehicle, such as a vehicle speed, the Revolutions Per Minute (RPM) of an engine and the temperature of cooling water, using an On Board Diagnostics (OBD), collect information about trouble of a vehicle using Electronic Control Unit (ECU), and then provide the collected information to drivers.

Further, such a vehicle driving information provision apparatus communicates with a local server installed on a roadside and collects information about the status of a road, such as the status of a roadside, from a traffic management center through the local server, and provides the collected information to drivers.

As described above, when a vehicle driving information provision apparatus repeatedly provides information about the operation of a vehicle, such as information about the trouble of a vehicle and information about the status of a road, to a driver, or provides even unnecessary information about the operation of a vehicle to a driver, it may interfere with the safe driving of a driver.

Therefore, information about the operation of a vehicle should be provided to a driver at an appropriate time so that the driver can be prevented from being faced with a dangerous situation while not interfering with the driving of the driver.

### SUMMARY OF THE INVENTION

Accordingly, the present invention has been made keeping in mind the above problems occurring in the prior art, and an object of the present invention is to provide a vehicle driving information provision apparatus and method for analyzing various situations which occur to a vehicle traveling on the road and notifying a driver of a dangerous situation.

In order to accomplish the above object, the present invention provides a vehicle driving information provision method, including: receiving information about the operation of a vehicle (hereinafter referred to as “vehicle driving information”); collecting information about the location of the vehicle (hereinafter referred to as “vehicle location information”); determining whether the vehicle driving information corresponds to information about a traffic situation that has occurred ahead of the vehicle using the vehicle location information; if the vehicle driving information is determined to be the information about a traffic situation that has occurred ahead of the vehicle, determining whether the traffic situation is a dangerous situation; and if the traffic situation is determined to be a dangerous situation, delivering a warning message corresponding to the vehicle driving information.

A vehicle driving information provision apparatus according to an aspect of the invention is installed in a vehicle, and configured to include a communication unit, a location information collection unit, a control unit and a warning delivery unit. The communication unit receives vehicle driving information from a server installed on a roadside, the vehicle driving information corresponding to a managing section of the server. The location information collection unit collects vehicle location information, including information about latitude, longitude and direction of the vehicle. If the vehicle driving information corresponds to traffic situation that has occurred ahead of the vehicle based on the vehicle location information, the control unit determines whether the traffic situation is a dangerous situation using the vehicle driving information. If the control unit determines that the traffic situation is a dangerous situation, the warning delivery unit delivers a warning message corresponding to the vehicle driving information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a road-vehicle situation management system according to an embodiment of the present invention;

FIG. 2 is a block diagram illustrating the configuration of a vehicle terminal according to an embodiment of the present invention;

FIG. 3 is a flowchart illustrating an urgent message transmission method according to a first embodiment of the present invention;

FIG. 4 is a flowchart illustrating an urgent message reception method according to the embodiment of the present invention;

FIG. 5 is a flowchart illustrating an urgent message transmission method according to a second embodiment of the present invention;

FIG. 6 is a flowchart illustrating a road status information transmission method according to an embodiment of the present invention;

FIG. 7 is a flowchart illustrating a road status information reception method according to the embodiment of the present invention;

FIG. 8 is a flowchart illustrating an abnormal vehicle information transmission method according to an embodiment of the present invention;

FIG. 9 is a flowchart illustrating an abnormal vehicle information reception method according to the embodiment of the present invention;

FIG. 10 is a flowchart illustrating a recommended speed information transmission method according to an embodiment of the present invention; and

FIG. 11 is a flowchart illustrating a recommended speed information reception method according to the embodiment of the present invention.

### DESCRIPTION OF THE PREFERRED EMBODIMENTS

The present invention will be described in detail with reference to the accompanying drawings below. Here, when repeated description and detailed descriptions of well-known functions or configurations may unnecessarily obscure the gist of the present invention, the detailed descriptions will be omitted. The embodiments of the present invention are provided to further completely explain to those skilled in the art the present invention. Therefore, the shapes and sizes of components in the drawings may be exaggerated for the sake of a more exact description.

A vehicle driving information provision apparatus and method according to an embodiment of the present invention will be described with reference to the accompanying drawings.

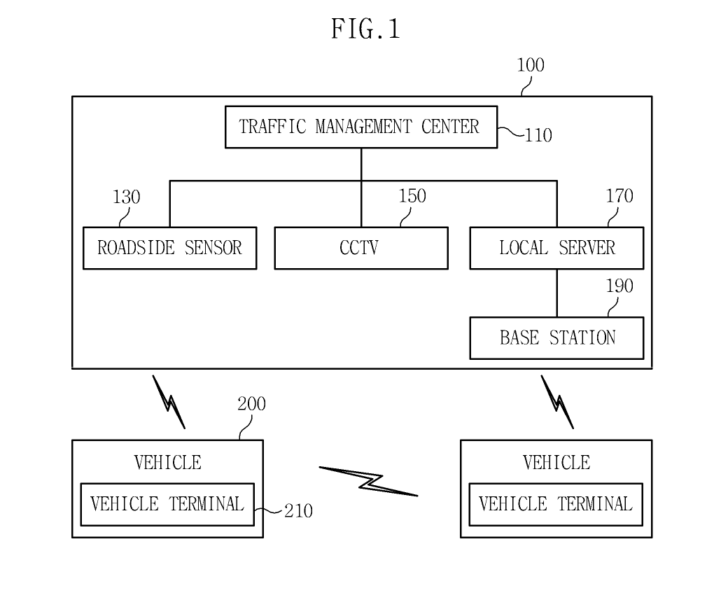

First, a road-vehicle situation management system according to an embodiment of the present invention will be described with reference to FIG. 1.

FIG. 1 is a block diagram illustrating the configuration of a road-vehicle situation management system according to an embodiment of the present invention.

As shown in FIG. 1, a road-vehicle situation management system 100 provides information about the situation necessary for the operation of a traveling vehicle in an environment in which vehicle status information and road status information can be collected in real time, and includes a traffic management center 110, a roadside sensor 130, a Closed-Circuit Television (CCTV) 150, a local server 170, and a base station 190. Here, a vehicle 200 includes a vehicle terminal 210 capable of analyzing the status of the vehicle 200 and the driving habits of a driver.

The traffic management center 110 collects the vehicle status information and the road status information from the roadside sensor 130, the CCTV 150 and the local server 170, and transmits the collected information to the local server 170. Here, the traffic management center 110 may collect the road status information using the images of roads or weather information.

The roadside sensor 130 is installed on the roadside of a road and configured to detect the road surface status of the road and to transmit detected road surface status information to the local server 130. Here, the roadside sensor 130 may correspond to a radar sensor or a road environment sensor.

The CCTV 150 obtains the images of a road, and transmits the obtained images to the traffic management center 110.

The local server 170 is installed on the roadside of a road, configured to collect the vehicle status information and the road status information from the traffic management center 110, the roadside sensor 130, and the vehicle 200, and configured to provide situation information, which is necessary for the travel of a vehicle, to cars which are traveling through a managing section.

The base station 190 communicates with the vehicle terminal 210 of the vehicle 200 which is traveling through the managing section of the local server 170.

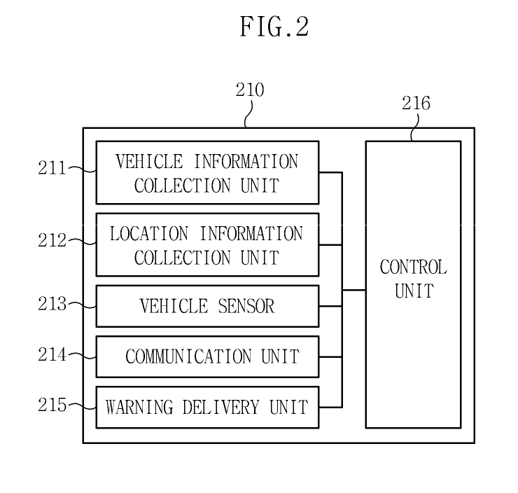

Next, a vehicle terminal corresponding to a vehicle driving information provision apparatus according to an embodiment of the present invention will be described with reference to FIG. 2.

FIG. 2 is a block diagram illustrating the configuration of the vehicle terminal according to an embodiment of the present invention.

As shown in FIG. 2, the vehicle terminal 210 includes a vehicle information collection unit 211, a location information collection unit 212, a vehicle sensor 213, a communication unit 214, a warning delivery unit 215, and a control unit 216.

The vehicle information collection unit 211 collects vehicle speed, battery voltage, cooling water temperature, and Diagnostic Trouble Code (DTC) from an Electronic Control Unit (ECU) using an On-Board Diagnostics version-II (OBD-II) interface.

The location information collection unit 212 collects information about the latitude, longitude, and direction of the vehicle 200.

The vehicle sensor 213 is installed in a vehicle and is configured to detect the road surface status in real time. Here, the vehicle sensor 213 may detect friction of a tire with the road surface, obstacles ahead on the road, and the road surface status of the road ahead.

The communication unit 214 performs wireless communication with neighboring vehicles or the base station 190.

The warning delivery unit 215 delivers a warning screen or warning sound, thereby warning the driver of the vehicle 200 of a dangerous situation.

The control unit 216 determines a dangerous situation using information about the operation of the vehicle which was received through the communication unit 214.

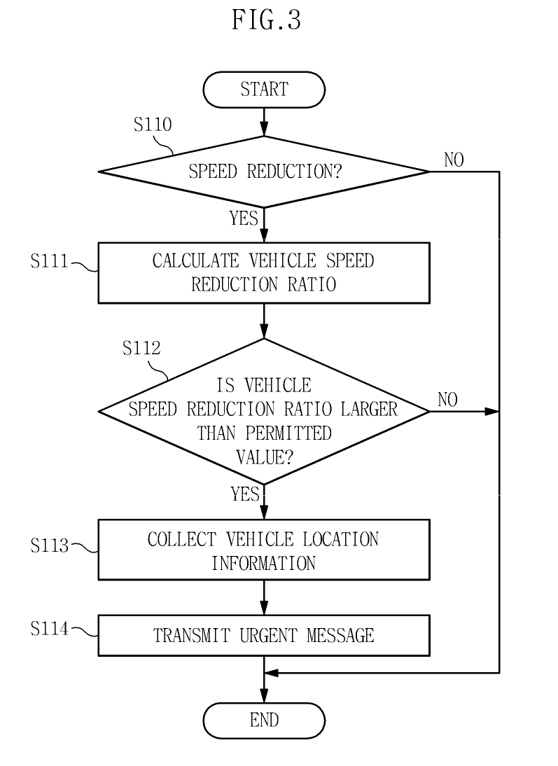

Next, a method of transmitting an urgent message to a neighboring vehicle using the vehicle driving information provision apparatus according to a first embodiment of the present invention will be described with reference to FIG. 3.

FIG. 3 is a flowchart illustrating an urgent message transmission method according to the first embodiment of the present invention.

As shown in FIG. 3, the vehicle information collection unit 211 of the vehicle terminal 210 first determines whether the speed of the vehicle 200 is reduced using information collected using an ECU at step S110.

If, as a result of the determination at step S110, the speed of the vehicle 200 is reduced, the control unit 216 of the vehicle terminal 210 calculates a vehicle speed reduction ratio which indicates the ratio of the speed of the vehicle 200 obtained before the speed reduction to the speed of the vehicle 200 obtained after the speed reduction at step S111.

Next, the control unit 216 of the vehicle terminal 210 compares the vehicle speed reduction ratio with a predetermined permitted value, and determines whether the speed reduction ratio is larger than the permitted value at step S112.

If, as the result of the determination at step S112, the vehicle speed reduction ratio is larger than the permitted value, the location information collection unit 212 of the vehicle terminal 210 collects the information about the location of the vehicle 200 at step S113. Here, the information about the location of the vehicle 200 includes information about the latitude, longitude, and direction of the vehicle 200.

Thereafter, the communication unit 214 of the vehicle terminal 210 transmits an urgent message, including the vehicle speed reduction ratio, the speed of the vehicle 200 obtained after speed reduction and the information about the location of the vehicle 200, to at least one neighboring vehicle at step S114. Here, the communication unit 214 of the vehicle terminal 210 may transmit the urgent message to the base station 190, and the base station 190 may transmit the urgent message received from the vehicle terminal 210 to the local server 170.

If, as the result of the determination at step S110, the speed of the vehicle 200 is not reduced, the control unit 216 of the vehicle terminal 210 ends the urgent message transmission method.

Based on the result of the determination at step S112, when the vehicle speed reduction ratio is not larger than the permitted value, the control unit 216 of the vehicle terminal 210 ends the urgent message transmission method.

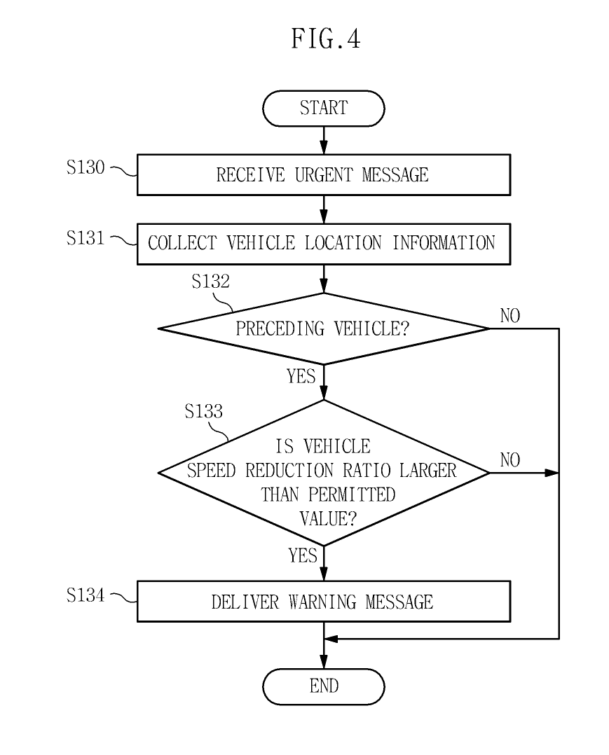

Next, a method of receiving an urgent message from at least one neighboring vehicle using the vehicle driving information provision apparatus according to an embodiment of the present invention will be described with reference to FIG. 4.

FIG. 4 is a view illustrating an urgent message reception method according to the embodiment of the present invention.

As shown in FIG. 4, the communication unit 214 of the vehicle terminal 210 first receives an urgent message, including a vehicle speed reduction ratio, the speed of a neighboring vehicle and information about the location of the neighboring vehicle, from the neighboring vehicle at step S130. Here, the communication unit 214 of the vehicle terminal 210 may receive an urgent message from the base station 190, and the base station 190 may transmit the urgent message, received from the local server 170, to the vehicle terminal 210.

Next, the location information collection unit 212 of the vehicle terminal 210 collects information about the location of the vehicle 200 at step S131. Here, the information about the location of the vehicle 200 includes information about the latitude, longitude and direction of the vehicle 200.

Thereafter, the control unit 216 of the vehicle terminal 210 compares the information about the location of the neighboring vehicle, included in the urgent message, with the information about the location of the vehicle 200, and determines whether the neighboring vehicle precedes the vehicle 200 at step S132.

If, as a result of the determination at step S132, the neighboring vehicle precedes the vehicle 200, the control unit 216 of the vehicle terminal 210 compares the vehicle speed reduction ratio, included in the urgent message, with a predetermined permitted value, and determines whether the vehicle speed reduction ratio is larger than the permitted value at step S133.

If, as a result of the determination at step S133, the vehicle speed reduction ratio is larger than the permitted value, the warning delivery unit 215 of the vehicle terminal 210 delivers a warning message used to warn of a dangerous situation due to the speed reduction of the preceding vehicle at step S134. Here, the warning delivery unit 215 of the vehicle terminal 210 may warn the driver of the vehicle 200 of a dangerous situation in such a way as to deliver a warning screen or a warning sound.

If, as the result of the determination at step S132, the neighboring vehicle does not precede the vehicle 200, the control unit 216 of the vehicle terminal 210 ends the urgent message reception method.

If, as the result of the determination at step S133, the vehicle speed reduction ratio is not larger than the permitted value, the control unit 216 of the vehicle terminal 210 ends the urgent message reception method.

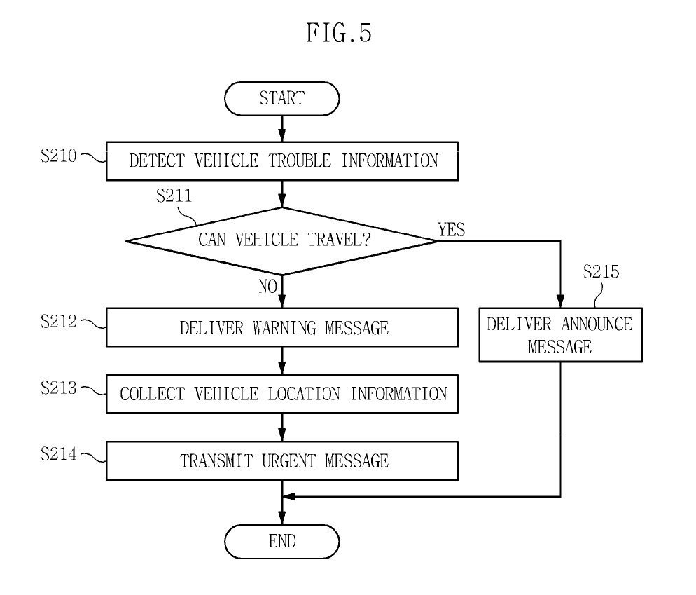

Next, a method of transmitting an urgent message to a neighboring vehicle using the vehicle driving information provision apparatus according to a second embodiment of the present invention will be described with reference to FIG. 5.

FIG. 5 is a flowchart illustrating an urgent message transmission method according to the second embodiment of the present invention.

As shown in FIG. 5, first, the vehicle information collection unit 211 of the vehicle terminal 210 detects information about the trouble of the vehicle 200 from information collected using the ECU at step S210. Here, the information about the trouble of the vehicle 200 may include a DTC and a DTC occurring time.

Next, the control unit 216 of the vehicle terminal 210 determines whether the vehicle 200 can travel based on the detected information about the trouble using pre-stored trouble data at step S211.

If, as a result of the determination at step S211, the vehicle 200 cannot travel, the warning delivery unit 215 of the vehicle terminal 210 delivers a warning message used to warn of a dangerous situation due to the trouble of the vehicle 200 at step S212. Here, the warning delivery unit 215 of the vehicle terminal 210 may warn the driver of the vehicle 200 of a dangerous situation in such a way as to deliver a warning screen or a warning sound.

Thereafter, the location information collection unit 212 of the vehicle terminal 210 collects information about the location of the vehicle 200 at step S213. Here, the information about the location of the vehicle 200 includes information about the latitude, longitude, and direction of the vehicle 200.

Next, the communication unit 215 of the vehicle terminal 210 transmits the urgent message, including the information about the trouble of the vehicle 200 and the information about the location of the vehicle 200, to a neighboring vehicle at step S214. Here, the communication unit 214 of the vehicle terminal 210 may transmit the urgent message to the base station 190, and the base station 190 may transmit the urgent message, received from the vehicle terminal 210, to the local server 170.

If, as the result of the determination at step S211, the vehicle 200 can travel, the warning delivery unit 215 of the vehicle terminal 210 delivers an announce message used to notify of the information about the trouble of the vehicle 200 at step S215.

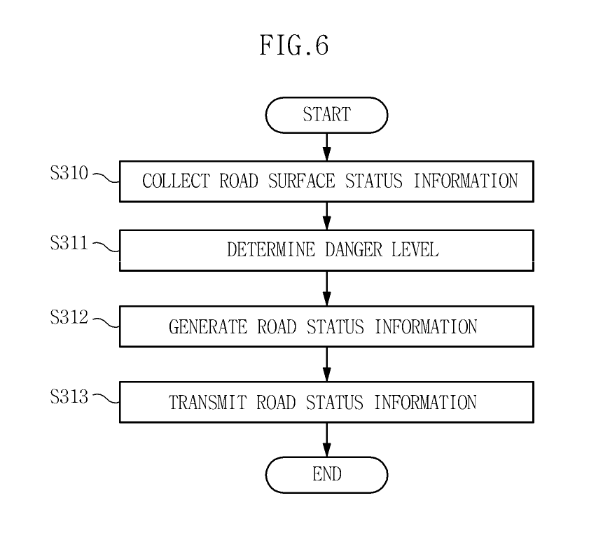

Next, a method of transmitting road status information to another vehicle using the local server according to an embodiment of the present invention will be described with reference to FIG. 6.

FIG. 6 is a flowchart illustrating a road status information transmission method according to the embodiment of the present invention.

As shown in FIG. 6, the local server 170 first collects road surface status information for a road at step S310. Here, the local server 170 may receive the road surface status information from the traffic management center 110, the roadside sensor 130 or the vehicle terminal 210. Here, the road surface status information may show weather, temperature, and “dry”, “wet”, “hydroplaning”, “snow”, “freezing”, and “fog” based on the local condition.

Next, the local server 170 determines the danger level of a road based on the collected road surface status information at step S311. Here, the local server 170 may assign high, medium, or low as the danger level of the road.

Thereafter, the local server 170 generates road status information including the road surface status information and the danger level at step S312. Here, the road status information may further include managing section information and the date and time that the road surface status information was collected. Here, the managing section information includes the latitude and longitude of a starting point and the latitude and longitude of an ending point.

Next, the local server 170 transmits the road status information to one or more vehicles which are traveling on a corresponding road using the base station 190 at step S313.

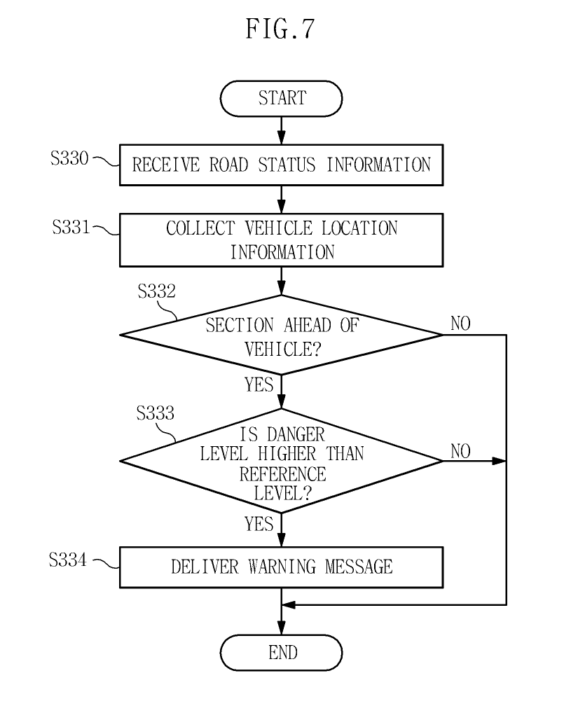

Next, a method of receiving the road status information using the vehicle driving information provision apparatus according to an embodiment of the present invention will be described with reference to FIG. 7.

FIG. 7 is a flowchart illustrating a road status information reception method according to the embodiment of the present invention.

As shown in FIG. 7, the communication unit 214 of the vehicle terminal 210 first receives the road status information, including managing section information and a danger level, from the base station 190 at step S330. Here, the road status information may further include road surface status information and the date and time that the road surface status information was collected.

Next, the location information collection unit 212 of the vehicle terminal 210 collects information about the location of the vehicle 200 at step S331. Here, the information about the location of the vehicle 200 includes information about the latitude, longitude, and direction of the vehicle 200.

Thereafter, the control unit 216 of the vehicle terminal 210 compares the managing section information, included in the road status information, with the information about the location of the vehicle 200, and determines whether the road status information is applied to the section ahead of the vehicle 200 at step S332.

If, as a result of the determination at step S332, the road status information is applied to the section ahead of the vehicle 200, the control unit 216 of the vehicle terminal 210 determines whether the danger level included in the road status information is higher than a reference level at step S333.

If, as a result of the determination at step S333, the danger level is higher than the reference level, the warning delivery unit 215 of the vehicle terminal 210 delivers a warning message used to warn of a dangerous situation due to the road surface status of the section ahead at step S334. Here, the warning delivery unit 215 of the vehicle terminal 210 may warn the driver of the vehicle 200 of a dangerous situation in such a way as to deliver a warning screen or a warning sound.

If, as the result of the determination at step S332, the road status information is not applied to the section ahead of the vehicle 200, the control unit 216 of the vehicle terminal 210 ends the road status information reception method.

If, as the result of the determination at step S333, the danger level is not higher than the reference level, the control unit 216 of the vehicle terminal 210 ends the road status information reception method.

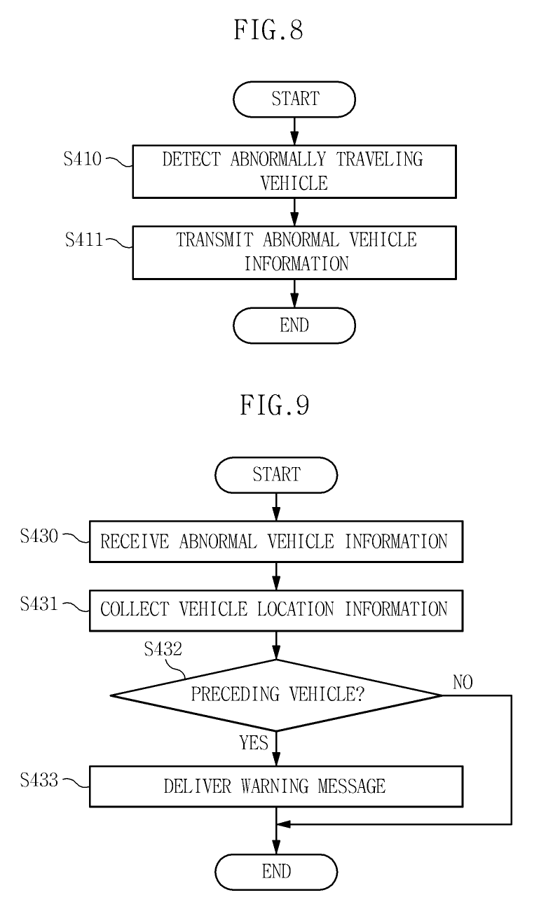

Next, a method of transmitting abnormal vehicle information to another vehicle using the local server according to an embodiment of the present invention will be described with reference to FIG. 8.

FIG. 8 is a flowchart illustrating an abnormal vehicle information transmission method according to the embodiment of the present invention.

As shown in FIG. 8, the local server 170 first analyzes the travel manner of one or more vehicles which are traveling within a managing section, and detects an abnormally traveling vehicle at step S410. Here, the local server 170 may determine a vehicle which has an unstable travel pattern, for example, an overspeeding/low speeding/stationary vehicle, a vehicle which frequently departs from a lane, or a vehicle which repeats the sudden acceleration/reduction of speed, as an abnormally traveling vehicle.

Next, the local server 170 transmits abnormal vehicle information, including information about the location of an abnormally traveling vehicle, to vehicles which are traveling through the managing section of the local server 170 using the base station 190 at step S411. Here, the information about the location of an abnormally traveling vehicle includes information about the latitude, longitude and direction of each abnormally traveling vehicle. Here, the abnormal vehicle information may further include the time that the abnormally traveling vehicle is found and the type of abnormal travel.

Next, a method of receiving the abnormal vehicle information using the vehicle driving information provision apparatus according to an embodiment of the present invention will be described with reference to FIG. 9.

FIG. 9 is a flowchart illustrating an abnormal vehicle information reception method according to an embodiment of the present invention.

As shown in FIG. 9, the communication unit 214 of the vehicle terminal 210 first receives abnormal vehicle information, including information about the location of an abnormally traveling vehicle, from the base station 190 at step S430. Here, the information about the location of an abnormally traveling vehicle includes information about the latitude, longitude and direction of the abnormally traveling vehicle.

Next, the location information collection unit 212 of the vehicle terminal 210 collects information about the location of the vehicle 200 at step S431. Here, the information about the location of the vehicle 200 includes information about the latitude, longitude, and direction of the vehicle 200.

Thereafter, the control unit 216 of the vehicle terminal 210 compares the information about the location of an abnormally traveling vehicle with the information about the location of the vehicle 200, and determines whether the abnormally traveling vehicle is the preceding vehicle of the vehicle 200 at step S432.

If, as a result of the determination at step S432, the abnormally traveling vehicle is the vehicle preceding the vehicle 200, the warning delivery unit 215 of the vehicle terminal 210 delivers a warning message used to warn of a dangerous situation due to the abnormally traveling vehicle at step S433. Here, the warning delivery unit 215 of the vehicle terminal 210 may warn the driver of the vehicle 200 of a dangerous situation in such a way as to deliver a warning screen or a warning sound.

If, as the result of the determination at step S432, the abnormally traveling vehicle is not the vehicle preceding the vehicle 200, the control unit 216 of the vehicle terminal 210 ends the abnormal vehicle information reception method.

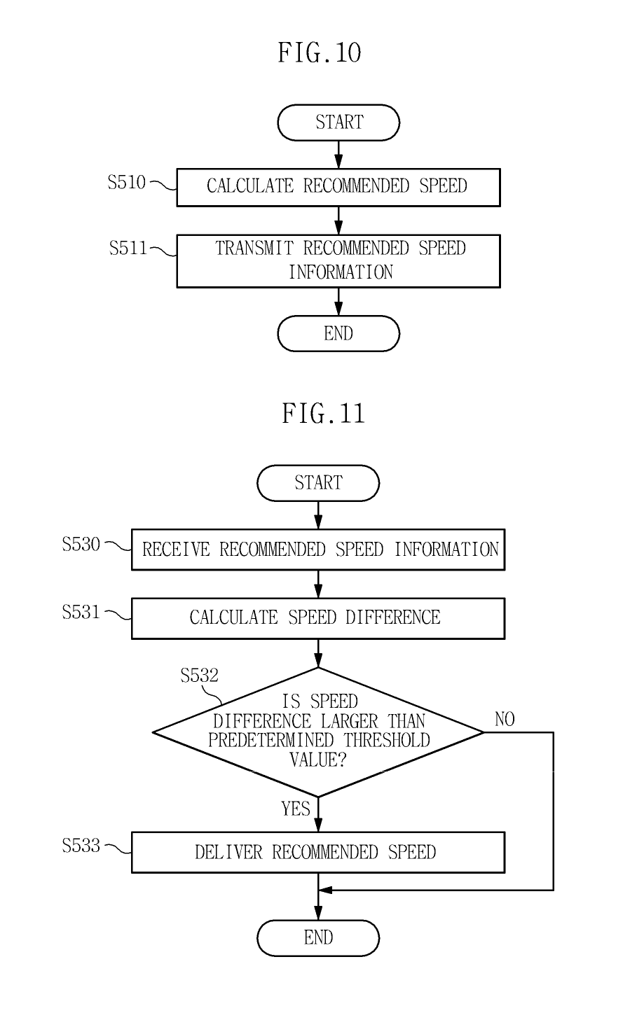

Next, FIG. 10 shows a method of transmitting recommended speed information to one or more vehicles using the local server according to an embodiment of the present invention.

FIG. 10 is a flowchart illustrating a recommended speed information transmission method according to an embodiment of the present invention.

As shown in FIG. 10, the local server 170 first calculates the recommended speed of a managing section at step S510. Here, the local server 170 may calculate the recommended speed or restricted speed in such a way as to analyze the road surface status information of a managing section, the number of traveling vehicles, or an average traveling speed.

Next, the local server 170 transmits the recommended speed information, including the recommended speed and the time that the recommended speed was calculated, to one or more vehicles which are traveling through the managing section of the local server 170 at step S511.

Next, a method of receiving the recommended speed information using the vehicle driving information provision apparatus according to an embodiment of the present invention will be described with reference to FIG. 11.

FIG. 11 is a flowchart illustrating a recommended speed information reception method according to the embodiment of the present invention.

As shown in FIG. 11, the communication unit 214 of the vehicle terminal 210 first receives recommended speed information, including recommended speed, from the base station 190 at step S530.

Next, the control unit 216 of the vehicle terminal 210 calculates a speed difference between the speed of the vehicle 200 and the recommended speed at step S531.

Thereafter, the control unit 216 of the vehicle terminal 210 determines whether the speed difference is larger than a predetermined threshold value at step S532.

If, as a result of the determination at step S532, the speed difference is larger than the threshold value, the warning delivery unit 215 of the vehicle terminal 210 delivers the recommended speed at step S533. Here, the warning delivery unit 215 of the vehicle terminal 210 may deliver the recommended speed using a screen or a sound.

If, as the result of the determination at step S532, the speed difference is not larger than the threshold value, the control unit 216 of the vehicle terminal 210 ends the recommended speed information reception method.

According to the feature of the present invention, a traffic situation is analyzed using information about the location of a vehicle and information about the operation of the vehicle, so that a warning message is delivered to a driver only when it is determined that the corresponding vehicle is in a dangerous situation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vehicle driving information provision method, comprising:
receiving vehicle driving information for a vehicle;
collecting vehicle location information of the vehicle;
determining whether the vehicle driving information corresponds to information about a traffic situation that has occurred ahead of the vehicle using the vehicle location information;
determining whether the traffic situation is a dangerous situation, if the vehicle driving information is determined to be the information about a traffic situation that has occurred ahead of the vehicle; and
delivering a warning message corresponding to the vehicle driving information if the traffic situation is determined to be the dangerous situation.

2. The vehicle driving information provision method as set forth in claim 1, wherein the vehicle driving information comprises at least one of sudden speed reduction information, abnormal vehicle information, road status information, vehicle trouble information and recommended speed information.

3. The vehicle driving information provision method as set forth in claim 2, wherein the determining whether the traffic situation is a dangerous situation comprises determining the traffic situation to be a dangerous situation when a vehicle speed reduction ratio included in the sudden speed reduction information is larger than a predetermined permitted value.

4. The vehicle driving information provision method as set forth in claim 3, wherein the determining whether the vehicle driving information corresponds to the information about a traffic situation comprises comparing preceding vehicle location information, included in the sudden speed reduction information, with the vehicle location information.

5. The vehicle driving information provision method as set forth in claim 2, wherein the determining whether the traffic situation is a dangerous situation comprises determining the traffic situation to be a dangerous situation when a danger level included in the road status information is higher than a predetermined reference level.

6. The vehicle driving information provision method as set forth in claim 5, wherein the determining whether the vehicle driving information corresponds to the information about a traffic situation comprises comparing applied section information, included in the road status information, with the vehicle location information.

7. The vehicle driving information provision method as set forth in claim 6, wherein the delivering the warning message comprises delivering the warning message corresponding to road surface status information included in the road status information.

8. The vehicle driving information provision method as set forth in claim 2, wherein the determining whether the vehicle driving information corresponds to the information about a traffic situation comprises comparing abnormally traveling vehicle location information, included in the abnormal vehicle information, with the vehicle location information.

9. The vehicle driving information provision method as set forth in claim 2, further comprising:
determining whether the vehicle can travel using the vehicle trouble information;
collecting the vehicle location information, if the vehicle cannot travel; and
transmitting the vehicle location information and the vehicle trouble information to at least one neighboring vehicle.

10. The vehicle driving information provision method as set forth in claim 9, wherein the vehicle trouble information comprises a diagnostic trouble code (DTC).

11. The vehicle driving information provision method as set forth in claim 10, wherein the determining whether the vehicle can travel comprises comparing the diagnostic trouble code with predetermined data.

12. The vehicle driving information provision method as set forth in claim 2, further comprising:
calculating a difference value between a recommended speed corresponding to the recommended speed information and a traveling speed of the vehicle; and
delivering the recommended speed information if the difference value is larger than a predetermined threshold.

13. The vehicle driving information provision method as set forth in claim 1, wherein the vehicle location information comprises information about latitude, longitude, and direction of the vehicle.

14. A vehicle driving information provision apparatus installed in a vehicle, comprising:
a communication unit for receiving vehicle driving information from a server installed on a roadside, the vehicle driving information corresponding to a managing section of the server;
a location information collection unit for collecting vehicle location information, including information about latitude, longitude and direction of the vehicle;
a control unit for, if the vehicle driving information corresponds to a traffic situation that has occurred ahead of the vehicle, determining whether the traffic situation is a dangerous situation using the vehicle driving information; and
a warning delivery unit for, if the control unit determines that the traffic situation is the dangerous situation, delivering a warning message corresponding to the vehicle driving information.

15. The vehicle driving information provision apparatus as set forth in claim 14, further comprising a vehicle information collection unit for collecting vehicle trouble information using an electronic control unit (ECU) of the vehicle, and wherein the communication unit transmits the vehicle trouble information and the vehicle location information to the server or at least one neighboring vehicle, if the control unit determines that the vehicle cannot travel based on the vehicle trouble information.

16. The vehicle driving information provision apparatus as set forth in claim 15, wherein the warning delivery unit delivers the warning message corresponding to the vehicle trouble information.

17. The vehicle driving information provision apparatus as set forth in claim 14, further comprising a sensor for detecting road surface status information and wherein the communication unit transmits the road surface status information to the server.

18. The vehicle driving information provision apparatus as set forth in claim 14, wherein the vehicle driving information comprises road surface status information of a road, which is collected using a sensor installed on the roadside.
